(19) United States
(12) Patent Application Publication
(10) Pub. No.: US 2015/0163724 A1
(43) Pub. Date: Jun. 11, 2015

(54) COMMUNICATION APPARATUS AND CONTROL METHOD THEREOF

(71) Applicant: CANON KABUSHIKI KAISHA, Tokyo (JP)

(72) Inventor: Akihiro Tanabe, Tokyo (JP)

(21) Appl. No.: 14/562,175

(22) Filed: Dec. 5, 2014

(30) Foreign Application Priority Data
Dec. 9, 2013 (JP) 2013-254489

(51) Int. Cl. H04W 48/08; H04W 4/00

(52) U.S. Cl. CPC H04W 48/08; H04W 4/008; H04W 84/12

(57) ABSTRACT

A communication apparatus includes a first communication interface configured to connect the communication apparatus to an external device by first communication, and a second communication interface configured to connect the communication apparatus to the external device by second communication different from the first communication. The controller of the communication apparatus controls to share a communication parameter used to connect the communication apparatus to the external device via the first communication interface with the external device via the second communication interface. The communication parameter includes the identification information of the communication apparatus defined by a type of communication protocol used in the first communication.

### BACKGROUND OF THE INVENTION

1. Field of the Invention

The present invention relates to a communication apparatus and a control method thereof.

2. Description of the Related Art

In recent years, mechanisms for ordering an article via a wireless LAN (Local Area Network) have become possible. In addition, performing authentication by NFC (Near Field Communication) when purchasing an article has also become possible. For example, a system is considerable, which gives an order by communication using a wireless LAN or the like in advance, and after that, performs authentication by NFC when taking delivery of the article at the store of the order destination. For example, Japanese Patent Laid-Open No. 2012-138074 discloses a method of transmitting fixed identification information and document data to a server via a wireless LAN or the like and performing device authentication later using another communication means.

In the conventional method, however, since fixed identification information is always transmitted, a problem arises when the identification information needs to be changed dynamically. The problem may be what kind of information should be transferred when transferring information processed by communication such as wireless LAN communication to non-contact proximity communication such as NFC.

### SUMMARY OF THE INVENTION

The present invention correctly transfers information processed by wireless communication to non-contact proximity communication.

According to one aspect of the present invention, a communication apparatus comprises a first communication interface configured to connect the communication apparatus to an external device by first communication, a second communication interface configured to connect the communication apparatus to the external device by second communication different from the first communication, and a controller configured to control to share a communication parameter used to connect the communication apparatus to the external device via the first communication interface with the external device via the second communication interface, wherein the communication parameter includes identification information of the communication apparatus defined by a type of communication protocol used in the first communication.

Further features of the present invention will become apparent from the following description of exemplary embodiments (with reference to the attached drawings).

### BRIEF DESCRIPTION OF THE DRAWINGS

FIG. 1 is a view showing an example of the arrangement of a communication system according to an embodiment;

FIG. 2 is a block diagram showing an example of the arrangement of a mobile terminal according to the embodiment;

FIG. 3 is a block diagram showing an example of the arrangement of a communication apparatus according to the embodiment;

FIGS. 4A to 4C are views showing examples of the data structure of identification information according to the embodiment;

FIGS. 5A and 5B are views showing examples of a data structure including device identification information according to the embodiment;

FIG. 6 is a flowchart showing an example of wireless communication processing of the mobile terminal according to the embodiment;

FIG. 7 is a flowchart showing an example of identification information generation processing of the mobile terminal according to the embodiment;

FIG. 8 is a flowchart showing processing of a server according to the embodiment;

FIG. 9 is a flowchart showing an example of wireless communication processing of the communication apparatus according to the embodiment;

FIG. 10 is a flowchart showing an example of non-contact proximity communication processing of the communication apparatus according to the embodiment;

FIG. 11 is a flowchart showing an example of non-contact proximity communication processing of the mobile terminal according to the embodiment;

FIG. 12 is a flowchart showing an example of wireless communication processing of a mobile terminal according to the second embodiment; and

FIG. 13 is a flowchart showing an example of non-contact proximity communication processing of the mobile terminal according to the second embodiment.

### DESCRIPTION OF THE EMBODIMENTS

Various exemplary embodiments, features, and aspects of the invention will be described in detail below with reference to the drawings.

Preferred embodiments of the present invention will now be described in detail with reference to the accompanying drawings. Note that the present invention is not limited to the following embodiments, and the embodiments are merely detailed examples advantageous in implementing the present invention. In addition, not all the combinations of features described in the following embodiments are essential to the solution of the problem of the present invention.

### First Embodiment

The first embodiment of the present invention will be described below in detail with reference to the accompanying drawings.

<System Arrangement>

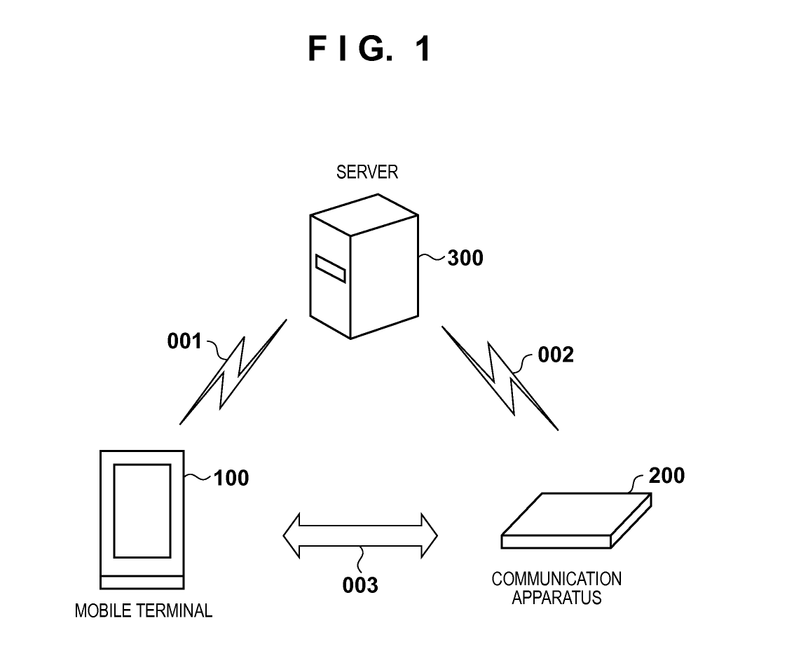

A communication system according to the first embodiment is formed from a mobile terminal 100, a communication apparatus 200, and a server 300 which can communicate with each other, as shown in FIG. 1. The mobile terminal is, for example, a smartphone. Communication 001 performed between the mobile terminal 100 and the server 300 can be, for example, wireless communication such as wireless LAN communication or Bluetooth®. Non-contact proximity communication 003 such as NFC is performed between the mobile terminal 100 and the communication apparatus 200. Communication 002 performed between the communication apparatus 200 and the server 300 includes wireless communication such as wireless LAN communication or Bluetooth or wired communication such as a wired LAN, and non-contact proximity communication such as NFC. More specifically, the communication apparatus 200 is a reader/writer device of NFC or the like. The mobile terminal 100 can receive a predetermined service from the server 300 via the communication 001. The server 300 stores data sent from the mobile terminal 100 and the communication apparatus 200 in an internal storage, and responds to various kinds of queries by the stored data.

<Arrangement of Mobile Terminal 100>

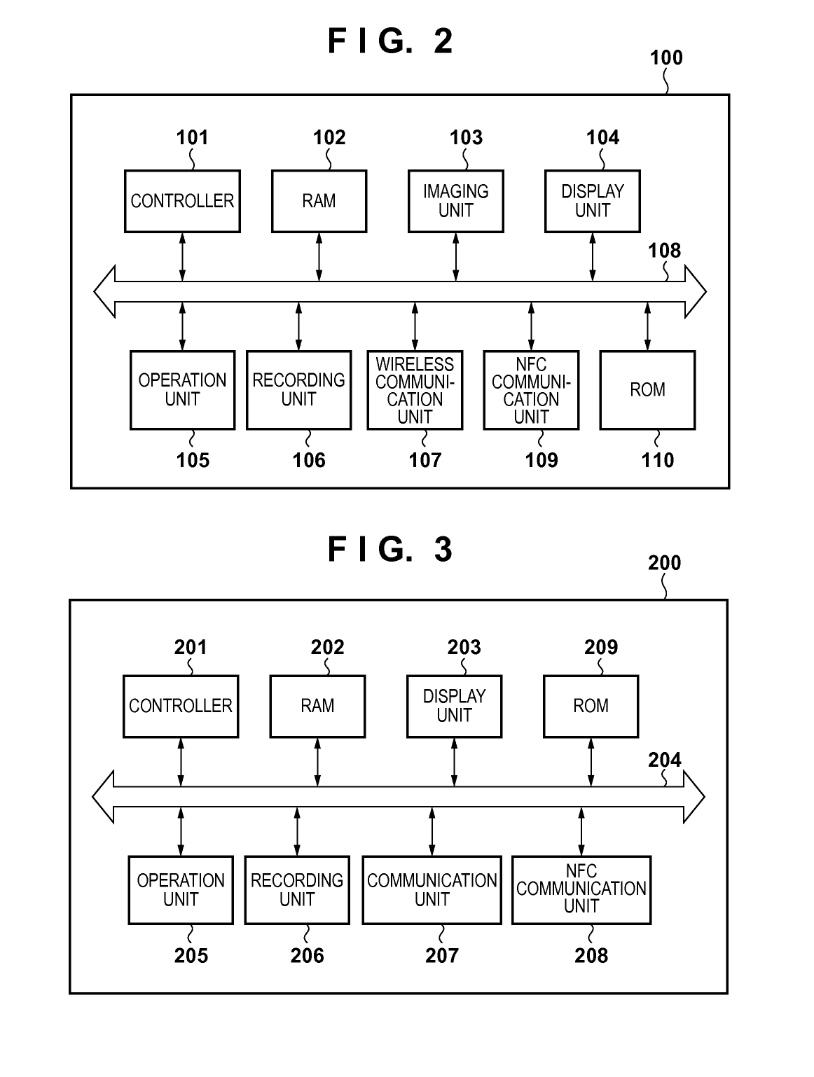

FIG. 2 is a block diagram showing the arrangement of the mobile terminal 100 according to this embodiment. A controller 101 is, for example, a CPU and controls all processing blocks of the mobile terminal 100. A ROM 110 stores permanent data and programs. A RAM 102 is a memory to be mainly used as the work area of the controller 101 or a temporary buffer area of data. Programs such as an OS (Operating System) and applications are loaded to the RAM 102 and executed by the controller 101.

An imaging unit 103 includes an optical lens, a CMOS sensor, a digital image processor, and the like. The imaging unit 103 converts an analog signal input via the optical lens into digital data and obtains a shot image. The shot image obtained by the imaging unit 103 is temporarily stored in the RAM 102 and processed under the control of the controller 101. For example, the shot image is recorded in a recording medium by a recording unit 106 or transmitted to an external device by a wireless communication unit 107. The imaging unit 103 also includes a lens controller and controls zooming, focusing, stop adjustment, and the like based on a command from the controller 101.

A display unit 104 is formed from a liquid crystal panel, an organic EL panel, or the like, and displays an operation screen, a shot image, or the like based on an instruction from the controller 101. The operation unit 105 is formed from buttons, a 4-way selector, a touch panel, a remote controller, or the like, and receives an operation instruction from the user. Operation information input from the operation unit 105 is transmitted to the controller 101. The controller 101 executes control of each processing block based on the operation information. The recording unit 106 is a processing block that is formed from a mass recording medium and stores or reads out various kind of data in or from the recording medium based on an instruction from the controller 101. The recording medium is formed from, for example, an internal flash memory, an internal hard disk, or a detachable memory card.

The wireless communication unit 107 is a processing block that includes an antenna, processing hardware configured to do communication such as wireless LAN communication, and the like, and performs wireless LAN communication of, for example, IEEE802.11n/a/g/b method. The wireless communication unit 107 is connected to an external access point via a wireless LAN and performs wireless LAN communication with another wireless communication device via the access point. An internal bus 108 connects the processing blocks in the mobile terminal 100 with each other. An NFC communication unit 109 is formed from an antenna and the like and has a communication function in each of the reader/writer mode, the initiator and target of the Peer mode, and the card emulation mode of NFC. In the reader/writer mode or the initiator of the Peer mode of NFC, an RF signal is output from the antenna, thereby performing non-contact proximity communication with an NFC tag or the like. This makes it possible to store (write) data in (the internal memory of) the NFC tag or read out data from the NFC tag. In the target of the Peer mode or the card emulation mode of NFC, a modulated RF signal is received from the antenna and stored in the RAM 102. The NFC communication unit 109 applies load modulation to the received RF signal and transmits a response signal.

<Arrangement of Communication Apparatus 200>

FIG. 3 is a block diagram showing the arrangement of the communication apparatus 200 according to this embodiment. A controller 201 is, for example, a CPU and controls all processing blocks of the communication apparatus 200. A ROM 209 stores permanent data and programs. A RAM 202 is a memory to be mainly used as the work area of the controller 201 or a temporary buffer area of data. A display unit 203 is formed from a liquid crystal panel, an organic EL panel, or the like, and displays an operation screen or the like based on an instruction from the controller 201. An internal bus 204 is a bus configured to connect the processing blocks in the communication apparatus 200 with each other. An operation unit 205 is formed from buttons, a 4-way selector, a touch panel, a remote controller, or the like, and receives an operation instruction from the user. Operation information input from the operation unit 205 is transmitted to the controller 201. The controller 201 executes control of each processing block based on the operation information. A recording unit 206 is a processing block that is formed from a mass recording medium and stores or reads out various kind of data in or from the recording medium based on an instruction from the controller 201. The recording medium is formed from, for example, an internal flash memory, an internal hard disk, or a detachable memory card.

A communication unit 207 includes hardware configured to do wireless LAN communication and wired LAN communication, and the like. In the wireless LAN, it is a processing block of, for example, IEEE802.11n/a/g/b method. The communication unit 207 is connected to an external access point via a wireless LAN and performs wireless LAN communication with another wireless communication device via the access point. In a wired LAN, the communication unit 207 performs communication using an Ethernet® cable via an external router or a switching hub.

An NFC communication unit 208 is formed from an antenna and a resonance circuit and has a communication function in each of the reader/writer mode, the initiator and target of the Peer mode, and the card emulation mode of NFC. In the reader/writer mode or the initiator of the Peer mode of NFC, an RF signal is output from the antenna, thereby performing non-contact proximity communication with an NFC tag or the like. This makes it possible to store (write) data in (the internal memory of) the NFC tag or read out data from the NFC tag. In the target of the Peer mode or the card emulation mode of NFC, a modulated RF signal is received from the antenna and stored in the RAM 202. The NFC communication unit 208 applies load modulation to the received RF signal and transmits a response signal.

<Structure of Identification Information>

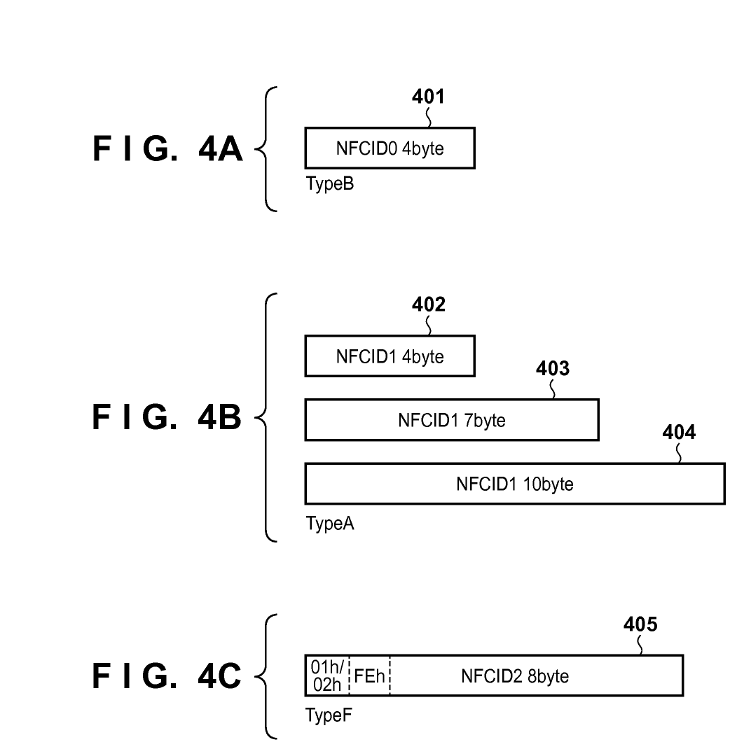

FIGS. 4A to 4C show examples of the data structure of identification information according to this embodiment. Identification information used in wireless communication or non-contact communication uses an NFCID (Near Field Communication Identification) defined by the NFC standard that is non-contact communication. FIG. 4A shows an NFCID0 401 defined by a communication method of type B. The NFCID0 401 has a 4-byte value generated at random. FIG. 4B shows NFCID1 402, 403, and 404 defined by a communication method of type A. The NFCID1 402, 403, and 404 are data formats having a 4-byte value, a 7-byte value, and a 10-byte value generated at random, respectively. FIG. 4C shows an NFCID2 405 defined by a communication method of type F. The NFCID2 405 has a value of total of 8 bytes. By setting the first byte to 01h and the second byte to FEh, the NFCID2 405 represents that it supports the NFC-DEP protocol. The remaining third to eighth bytes are generated at random. Alternatively, by setting the first byte to 02h and the second byte to FEh, the NFCID2 405 represents that it supports TagType3. The remaining third to eighth bytes are generated at random.

<Structure of Data Transmitted by Communication>

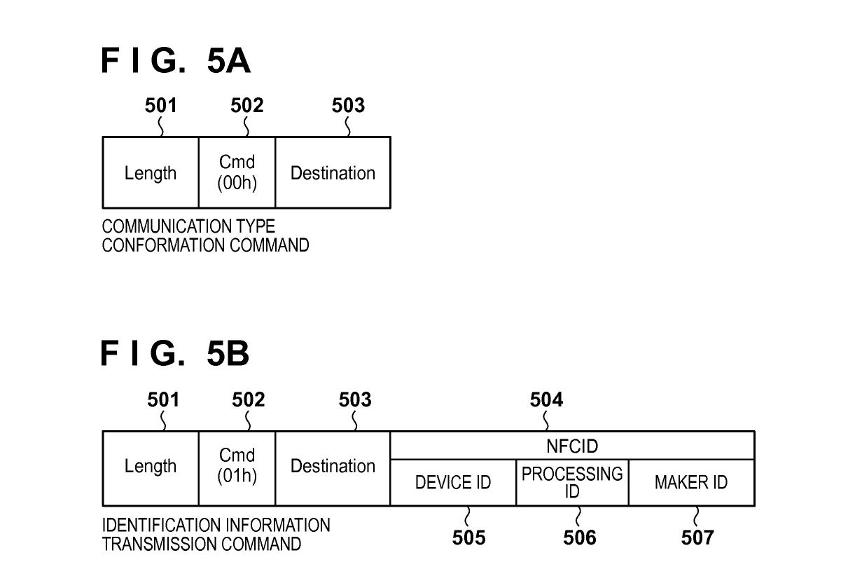

FIGS. 5A and 5B show examples of the format structure of communication data including identification information according to this embodiment. FIG. 5A defines a command to confirm the communication method. FIG. 5B defines a command to transmit identification information. The format of communication data includes Length 501, Command 502, Destination 503, an NFCID 504, a device ID 505, a processing ID 506, and a maker ID 507. The Length 501 represents the total length of the communication data. The Command 502 defines the command type of the communication data. For example, a value “00h” is set in the command to confirm the communication method shown in FIG. 5A. The Destination 503 stores address information representing a communication apparatus as a destination. A value “01h” is set in the command to transmit identification information shown in FIG. 5B. The NFCID 504 includes at least one of the device ID 505, the processing ID 506, and the maker ID 507. The device ID is an identifier to identify the mobile terminal 100, and can have a value generated at random or unique identification information. The processing ID 506 is an identifier to identify each processing. The maker ID 507 is an identifier to identify the maker of the mobile terminal 100.

<Ordering Procedure from Mobile Terminal 100>

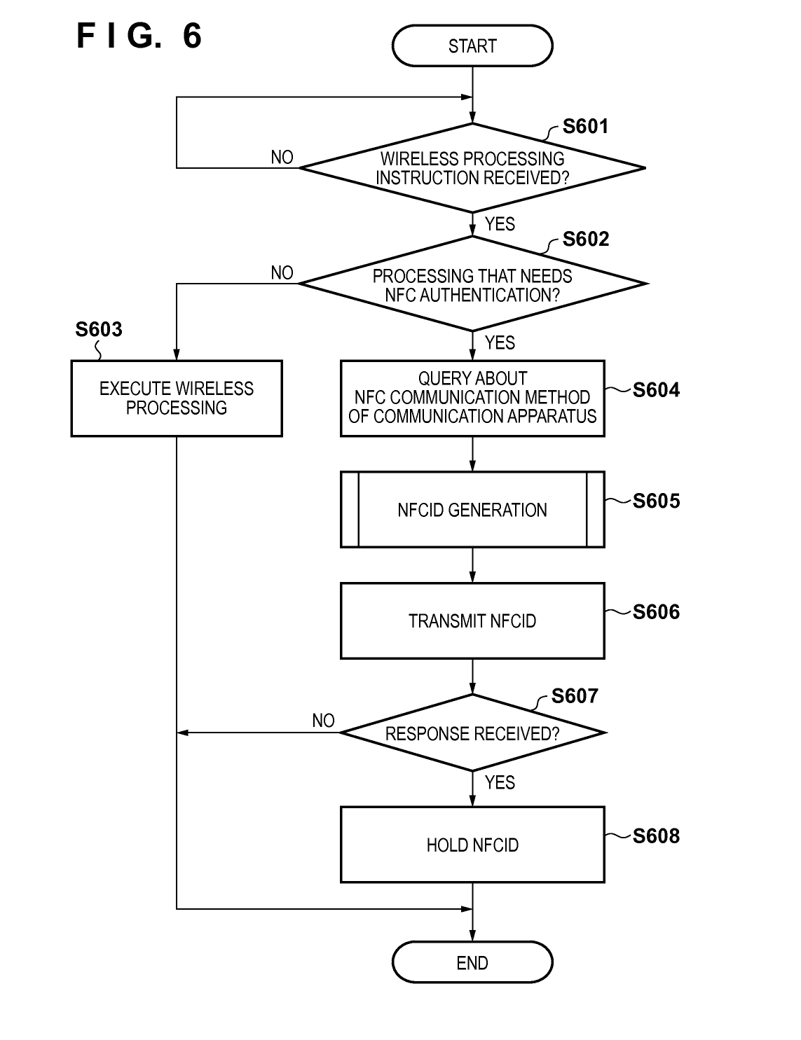

Wireless communication processing of the mobile terminal 100 according to this embodiment will be described with reference to FIG. 6. Note that a program corresponding to this flowchart is stored in, for example, the recording unit 106. The program is loaded from the recording unit 106 to the RAM 102 and executed by the controller 101 in the power-on state of the mobile terminal 100.

In step S601, the controller 101 determines whether a processing instruction that needs communication using the wireless communication unit 107 is received. The processing instruction is received from the user via the operation unit 105 or received as an instruction from an external device via the wireless communication unit 107. For example, a case where ordering processing is performed via the wireless communication can be assumed. Upon receiving a processing instruction that needs communication using the wireless communication unit 107 (YES in step S601), the process advances to step S602. Upon receiving no processing instruction that needs communication using the wireless communication unit 107 (NO in step S601), the process of step S601 is repeated.

In step S602, the controller 101 determines whether the processing instruction received in step S601 is processing that needs authentication by the NFC communication unit 109. As the processing that needs authentication by the NFC communication unit 109, for example, a case where an order is given via wireless communication, and authentication is performed by NFC when actually taking delivery of an article can be assumed. If the processing needs authentication by the NFC communication unit 109 (YES in step S602), the process advances to step S604. If the processing does not need authentication by the NFC communication unit 109 (NO in step S602), the process advances to step S603.

In step S603, the controller 101 controls the wireless communication unit 107 so as to perform predetermined wireless communication processing, and ends the processing of the flowchart.

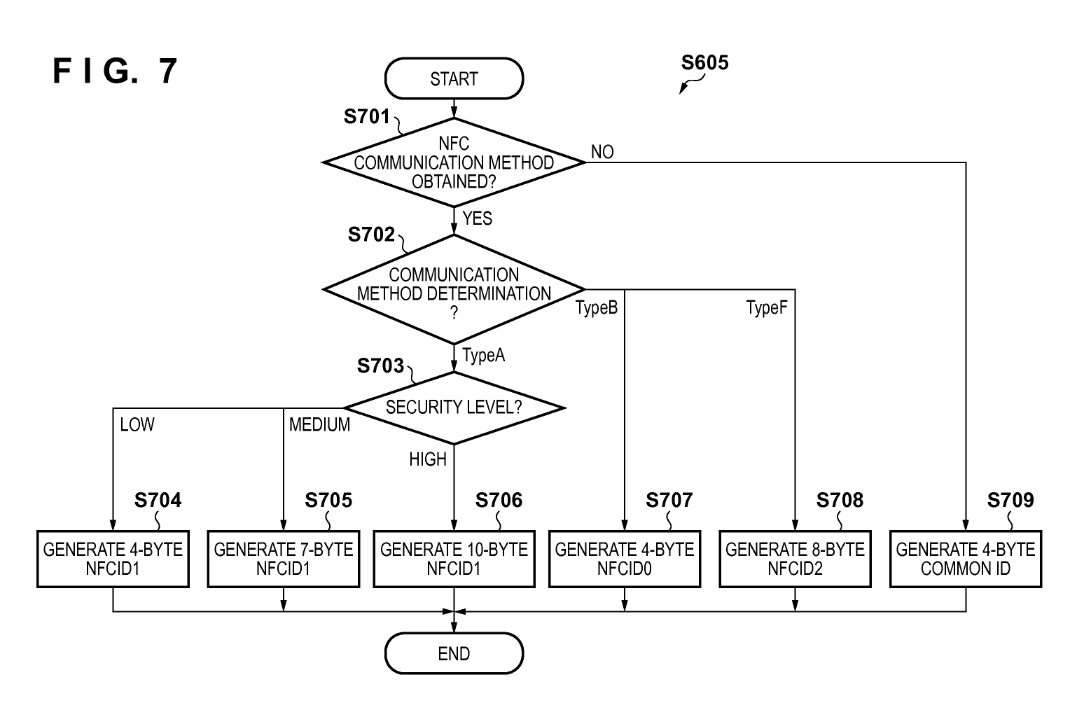

In step S604, the controller 101 queries the server 300 via the wireless communication unit 107 about the NFC communication method of the communication apparatus 200 that is planned to do NFC authentication. More specifically, a command to confirm the NFC communication method, as shown in FIG. 5A, is transmitted. In step S605, the controller 101 performs NFCID generation processing. This processing will be described later in detail with reference to FIG. 7. In step S606, the controller 101 transmits the generated NFCID to the server 300 via the wireless communication unit 107. For example, a command to transmit identification information, as shown in FIG. 5B, is transmitted. In step S607, the controller 101 determines whether a response to the command to transmit identification information is received via the wireless communication unit 107. Upon receiving a response to the command to transmit identification information within a predetermined time (YES in step S607), the controller 101 advances the process to step S608. If no response to the command to transmit identification information is received within a predetermined time (NO in step S607), the controller 101 ends the processing. In step S608, the controller 101 stores the NFCID generated in step S605 in the recording unit 106, and ends the processing.

<NFCID Generation Processing of Mobile Terminal 100>

Details of NFCID generation processing in step S605 will be described with reference to FIG. 7.

In step S701, the controller 101 determines whether response information to the command to confirm the NFC communication method is obtained via the wireless communication unit 107. Upon obtaining the response information (YES in step S701), the controller 101 advances the process to step S702. Upon obtaining no response information (NO in step S701), the controller 101 advances the process to step S709.

In step S702, the controller 101 determines the NFC communication method of the communication apparatus 200 from the received response information. If the NFC communication method is of type A, the process advances to step S703. If the NFC communication method is of type B, the process advances to step S707. If the NFC communication method is of type F, the process advances to step S708.

In step S703, the controller 101 determines the set value of the security level of communication of the NFC communication unit 109, which is preset by the recording unit 106. Note that there are three security levels, for example, “low”, “medium”, and “high”. If the security level is “low”, the process advances to step S704. If the security level is “medium”, the process advances to step S705. If the security level is “high”, the process advances to step S706.

In step S704, the controller 101 generates an NFCID1 having a data length of 4 bytes out of the NFCIDs, as shown in FIG. 4B, and stores it in the RAM 102.

In step S705, the controller 101 generates an NFCID1 having a data length of 7 bytes out of the NFCIDs, as shown in FIG. 4B, and stores it in the RAM 102. The increase in the byte length is adjusted by increasing the data length of the device ID 505 or appending another data.

In step S706, the controller 101 generates an NFCID1 having a data length of 10 bytes out of the NFCIDs, as shown in FIG. 4B, and stores it in the RAM 102. The increase in the byte length is adjusted by increasing the data length of the device ID 505 or appending another data.

In step S707, the controller 101 generates an NFCID0 having a data length of 4 bytes out of the NFCIDs, as shown in FIG. 4A, and stores it in the RAM 102.

In step S708, the controller 101 generates an NFCID2 having a data length of 8 bytes out of the NFCIDs, as shown in FIG. 4C, and stores it in the RAM 102. Note that when storing fixed values in the first two bytes of the NFCID2, identification information is stored in the remaining six bytes.

In step S709, the controller 101 generates a 4-byte NFCID commonly usable in the NFCID0, NFCID1, and NFCID2. If data of four or more bytes is necessary upon a query from the communication apparatus 200, fixed values are padded to the remaining bytes.

The mobile terminal 100 according to this embodiment thus controls the NFCID generation method based on information received via the wireless communication unit 107 in advance.

<Processing of Server 300>

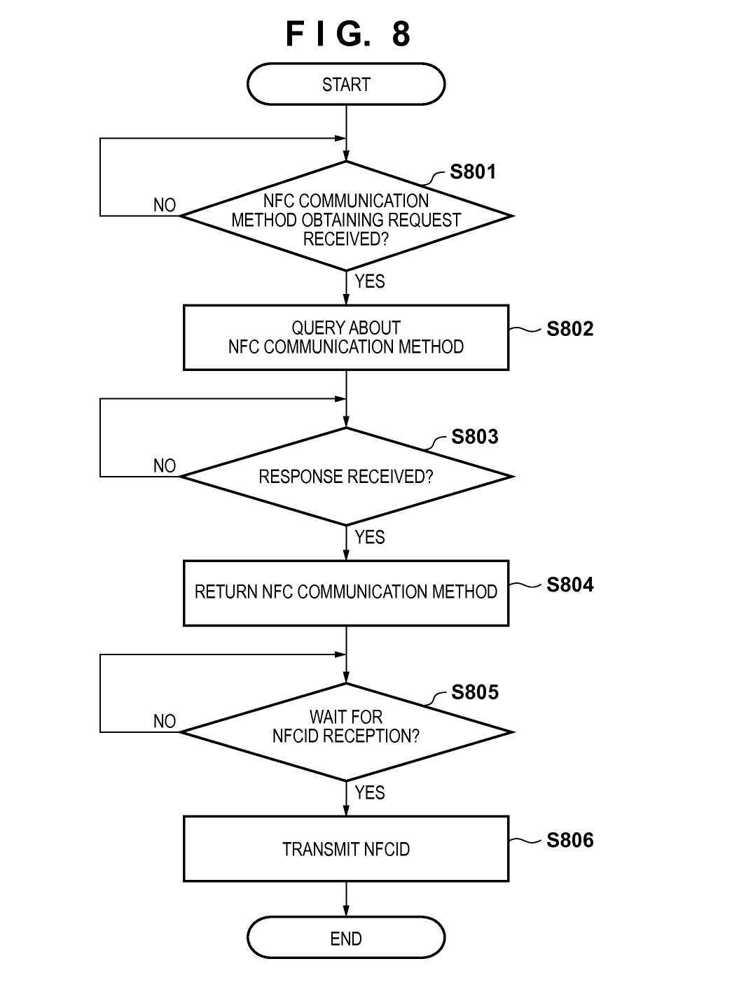

Communication processing of the server 300 according to this embodiment will be described with reference to FIG. 8.

In step S801, the server 300 determines whether a request (see step S604) to confirm the NFC communication method of the communication apparatus 200 is received from the mobile terminal 100. Upon receiving the request (YES in step S801), the server 300 advances the process to step S802. Upon receiving no request (NO in step S801), the server 300 repeats the process of step S801.

In step S802, the server 300 transmits an NFC communication method obtaining request to the communication apparatus 200. Upon receiving a response to the obtaining request from the communication apparatus 200 (YES in step S803), the server 300 advances the process to step S804. Upon receiving no response to the obtaining request (NO in step S803), the processing waits in step S803. In step S804, the server 300 transmits a response to the request received in step S801 to the mobile terminal 100. In step S805, the server 300 determines whether an NFCID query request is received from the mobile terminal 100. Upon receiving an NFCID query request from the mobile terminal 100 (YES in step S805), the server 300 advances the process to step S806. Upon receiving no NFCID query request from the mobile terminal 100 (NO in step S805), the server 300 returns to step S805 and waits. In step S806, the server 300 transmits the NFCID received from the mobile terminal 100 to the communication apparatus 200.

<NFCID Reception Processing of Communication Apparatus 200>

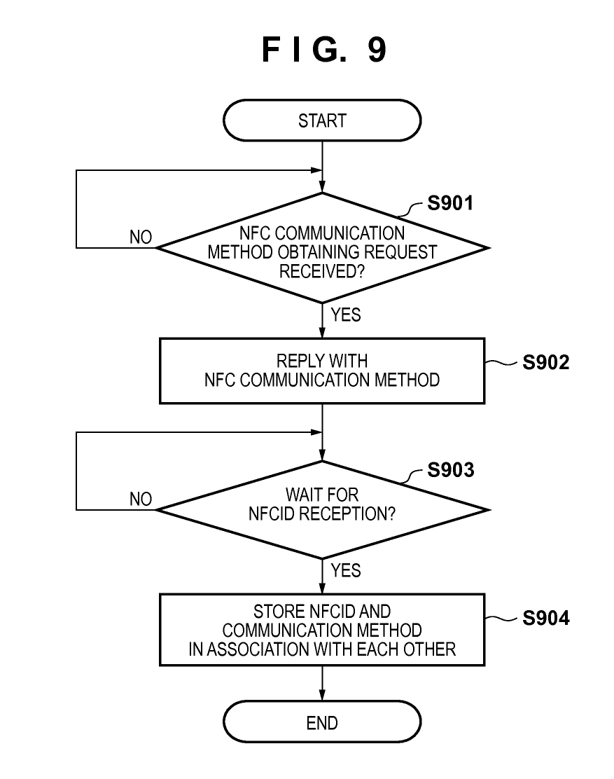

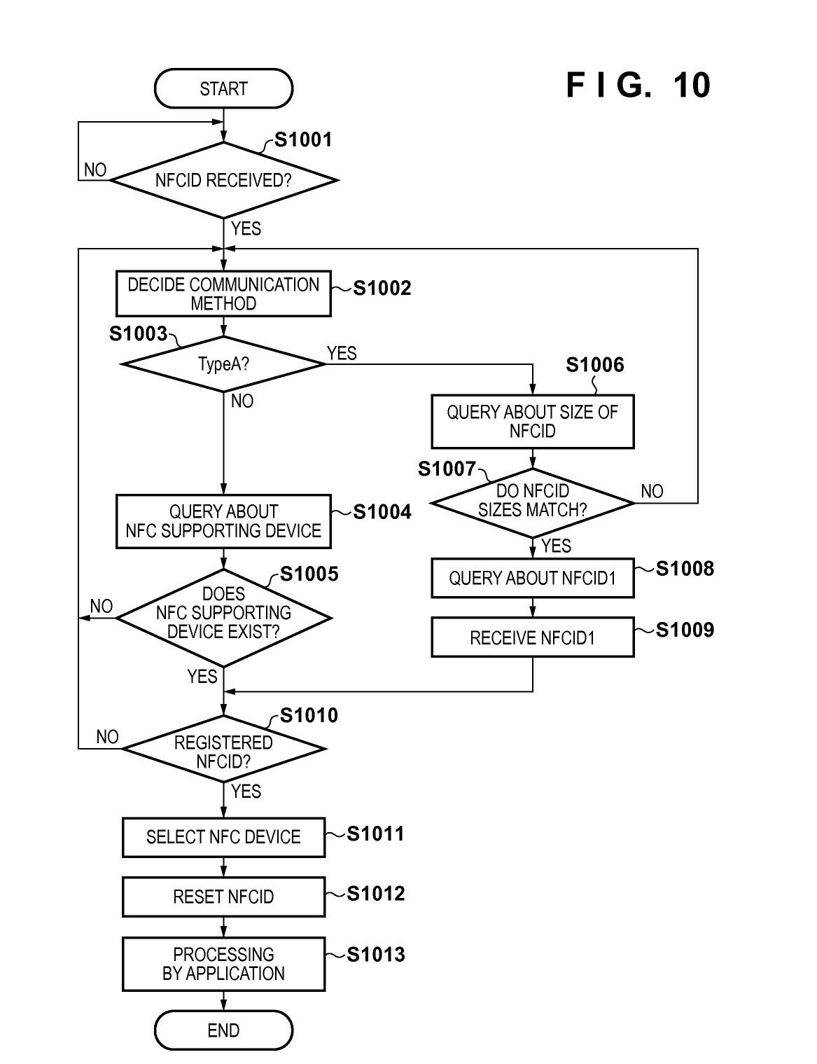

An example of NFCID reception processing of the communication apparatus 200 according to this embodiment will be described with reference to FIG. 9. Note that a program corresponding to the flowchart of FIG. 9 is stored in, for example, the recording unit 206. The program is loaded from the recording unit 206 to the RAM 202 and executed by the controller 201 in the power-on state of the communication apparatus 200.

In step S901, the controller 201 determines whether an NFC communication method obtaining request (see step S802) is received from the server 300 via the communication unit 207. Upon receiving an NFC communication method obtaining request (YES in step S901), the controller 201 advances the process to step S902. Upon receiving no NFC communication method obtaining request (NO in step S901), the controller 201 continues the process of step S901.

In step S902, the controller 201 returns the information of the communication method of the NFC communication unit 208 via the communication unit 207 in response to the received NFC communication method obtaining request. In step S903, the controller 201 determines whether an NFCID (see step S806) is received from the server 300 via the communication unit 207. Upon receiving an NFCID (YES in step S903), the controller 201 advances the process to step S904. Upon receiving no NFCID (NO in step S903), the controller 201 continues the process of step S903.

In step S904, the controller 201 stores the NFC communication method returned in step S902 and the NFCID received in step S903 in the recording unit 206 in association with each other.

<Authentication Processing of Communication Apparatus 200>

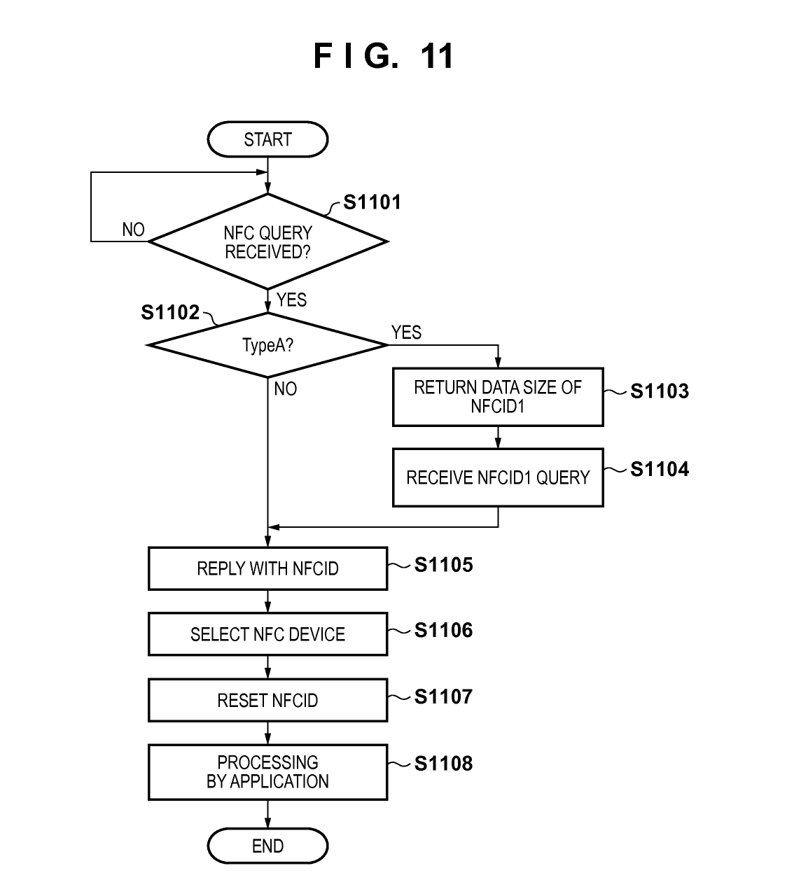

An example of NFC authentication processing of the communication apparatus 200 according to this embodiment will be described with reference to FIG. 10. Note that a program corresponding to the flowchart of FIG. 10 is stored in, for example, the recording unit 206. The program is loaded from the recording unit 206 to the RAM 202 and executed by the controller 201 in the power-on state of the communication apparatus 200. The processing shown in FIG. 10 can be executed in parallel to the processing shown in FIG. 9.

In step S1001, the controller 201 determines whether an NFCID is received via the communication unit 207. Upon receiving an NFCID (YES in step S1001), the controller 201 advances the process to step S1002. Upon receiving no NFCID (NO in step S1001), the controller 201 continues the process of step S1001.

In step S1002, the controller 201 decides the communication method of the NFC communication unit 208. The controller 201 obtains the NFC communication method returned in step S902 from the recording unit 206 and decides the same communication method. If the NFC communication method is of type A (YES in step S1003), the controller 201 advances the process to step S1006. If the NFC communication method is not of type A (NO in step S1003), the controller 201 advances the process to step S1004.

In step S1004, the controller 201 controls the NFC communication unit 208 in accordance with the NFC communication method decided in step S1002, and queries whether an NFC supporting device exists. For example, an SENSB_REQ command is transmitted for type B, or a SENSF_REQ command is transmitted for type F.

In step S1005, the controller 201 receives, via the NFC communication unit 208, a response to the command transmitted in step S1004, and determines whether an NFC supporting device exists. An SENSB_RES response is received for type B via the NFC communication unit 208, or a SENSF_RES response is received for type F. Note that when SENSB_RES is received, the value of the NFCID0 is stored in the RAM 202, and when SENSF_RES is received, the value of the NFCID2 is stored in the RAM 202. If an NFC supporting device exists (YES in step S1005), the controller 201 advances the process to step S1010. If no NFC supporting device exists (NO in step S1005), the controller 201 returns the process to step S1002.

In step S1006, the controller 201 transmits a SENS_REQ command via the NFC communication unit 208 to query the size of the NFCID of type A. In step S1007, the controller 201 receives a SENS_RES response via the NFC communication unit 208, and compares the size of the received NFCID1 with the size of the NFCID1 of the mobile terminal 100 recorded in the recording unit 206. If the size of the NFCID1 is the same as the size of the NFCID1 of the mobile terminal 100 (YES in step S1007), the controller 201 advances the process to step S1008. If the size of the NFCID1 is not the same as the size of the NFCID1 of the mobile terminal 100 (NO in step S1007), the controller 201 returns the process to step S1002.

In step S1008, the controller 201 controls the NFC communication unit 208 and transmits an SDD_REQ command to obtain the NFCID1. In step S1009, the controller 201 receives an SDD_RES response via the NFC communication unit 208 and stores the NFCID1 in the RAM 202. After that, the controller 201 advances the process to step S1010.

In step S1010, the controller 201 determines whether the NFCID stored in the RAM 202 matches the NFCID of the mobile terminal 100 stored in the recording unit 206. Upon determining that the NFCID is the registered NFCID (YES in step S1010), the controller 201 completes the authentication and advances the process to step S1011. Upon determining that the NFCID is not the registered NFCID (NO in step S1010), the controller 201 returns the process to step S1002.

In step S1011, the controller 201 performs predetermined processing to select the mobile terminal 100 via the NFC communication unit 208 because the NFCID is the registered NFCID. For example, when the NFC communication method is of type A, a SEL_REQ command or the like is issued to select the mobile terminal 100. In step S1012, the controller 201 deletes the information that associates the NFC communication method with the NFCID stored in the recording unit 206 and the information of the NFCID temporarily stored in the RAM 202. In step S1013, the controller 201 performs communication of an NFC application layer using the NDEF (NFC Data Exchange Format) in accordance with a desired application. For example, in ordering processing, processing such as settlement processing is performed.

<Authentication Processing of Mobile Terminal 100>

An example of authentication processing of the mobile terminal 100 according to this embodiment will be described with reference to FIG. 11. Note that a program corresponding to the flowchart of FIG. 11 is stored in, for example, the recording unit 106. The program is loaded from the recording unit 106 to the RAM 102 and executed by the controller 101 in the power-on state of the mobile terminal 100.

In step S1101, the controller 101 determines whether a request periodically transmitted from the communication apparatus 200 by polling to query whether an NFC supporting device exists is received. Note that if the request to query whether an NFC supporting device exists is of type A, SENS_REQ is received. If the query request is of type B, SENSB_REQ is received. If the query request is of type F, SENSF_REQ is received. Upon receiving a request to query whether an NFC supporting device exists (YES in step S1101), the controller 101 advances the process to step S1102. Upon receiving no request to query whether an NFC supporting device exists (NO in step S1101), the controller 101 returns to step S1101 and repeats the process.

In step S1102, the controller 101 determines whether a SENS_REQ command of type A is received. Upon determining that the command is of type A (YES in step S1102), the controller 101 advances the process to step S1103. Upon determining that the command is not of type A (NO in step S1102), the controller 101 advances the process to step S1105.

In step S1103, the controller 101 returns the data size of the NFCID1 of type A via the NFC communication unit 109. In step S1104, the controller 101 receives, via the NFC communication unit 109, an SDD_REQ command to obtain the NFCID1.

In step S1105, the controller 101 returns the NFCID via the NFC communication unit 109 and completes the authentication. For type A, the controller 101 returns the NFCID1 held in the recording unit 106 in step S608 by an SDD_RES response as a response to the SDD_REQ command. For type B, the controller 101 returns the NFCID0 held in the recording unit 106 in step S608 by an SENSB_RES response as a response to the SENSB_REQ command. For type F, the controller 101 returns the NFCID2 held in the recording unit 106 in step S608 by an SENSF_RES response as a response to the SENSF_REQ command.

In step S1106, the controller 101 returns a response to the device selection request from the communication apparatus 200, thereby completing the authentication. For example, if the NFC communication method is of type A, a SEL_RES response is returned in response to a SEL_REQ command from the communication apparatus 200. In step S1107, the controller 101 deletes the NFCID stored in the recording unit 106. In step S1108, the controller 101 performs communication of an NFC application layer using the NDEF (NFC Data Exchange Format) in accordance with a desired application. For example, in ordering processing, processing such as settlement processing is performed.

As described above, according to the processing of this embodiment, it is possible to associate wireless communication with non-contact proximity communication between the mobile terminal 100 and the communication apparatus 200 and authenticate the same device using an NFCID. Note that in this embodiment, processing via the server 300 has been described. However, the mobile terminal 100 and the communication apparatus 200 may directly communicate without intervening with the server 300.

### Second Embodiment

In the second embodiment to be described below, after a plurality of wireless processes are performed, authentication processing is performed for a plurality of communication apparatuses 200 by non-contact communication.

<Ordering Procedure from Mobile Terminal>

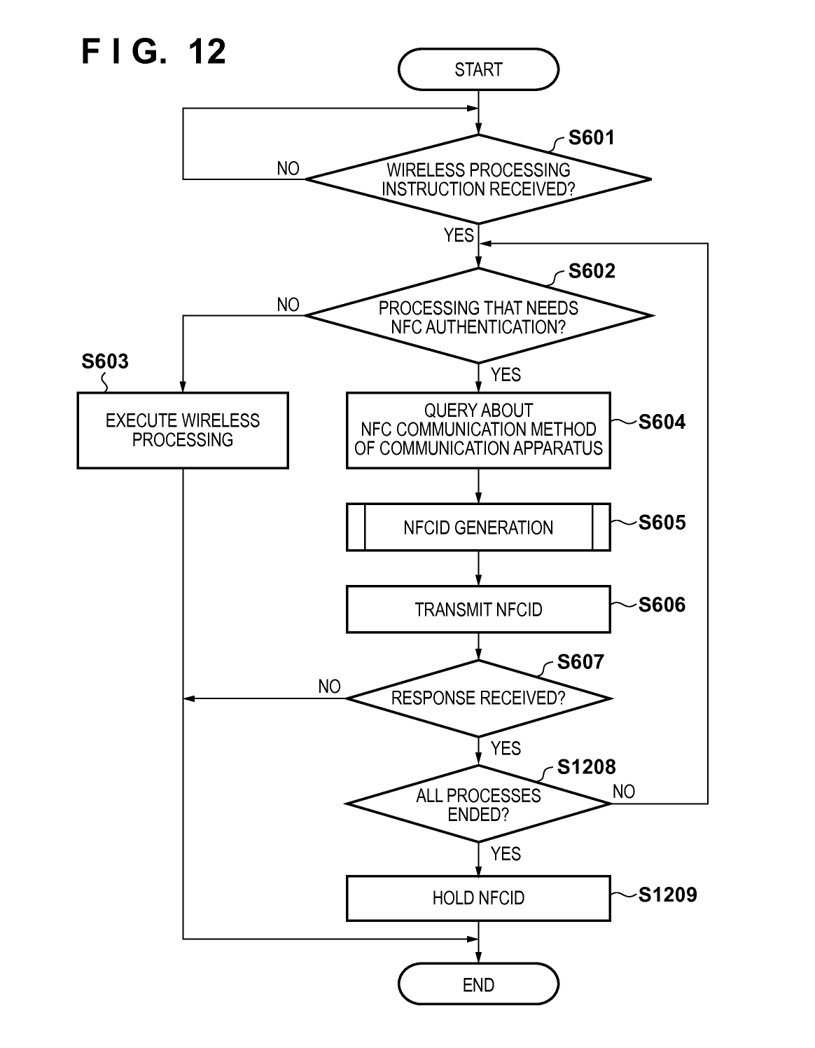

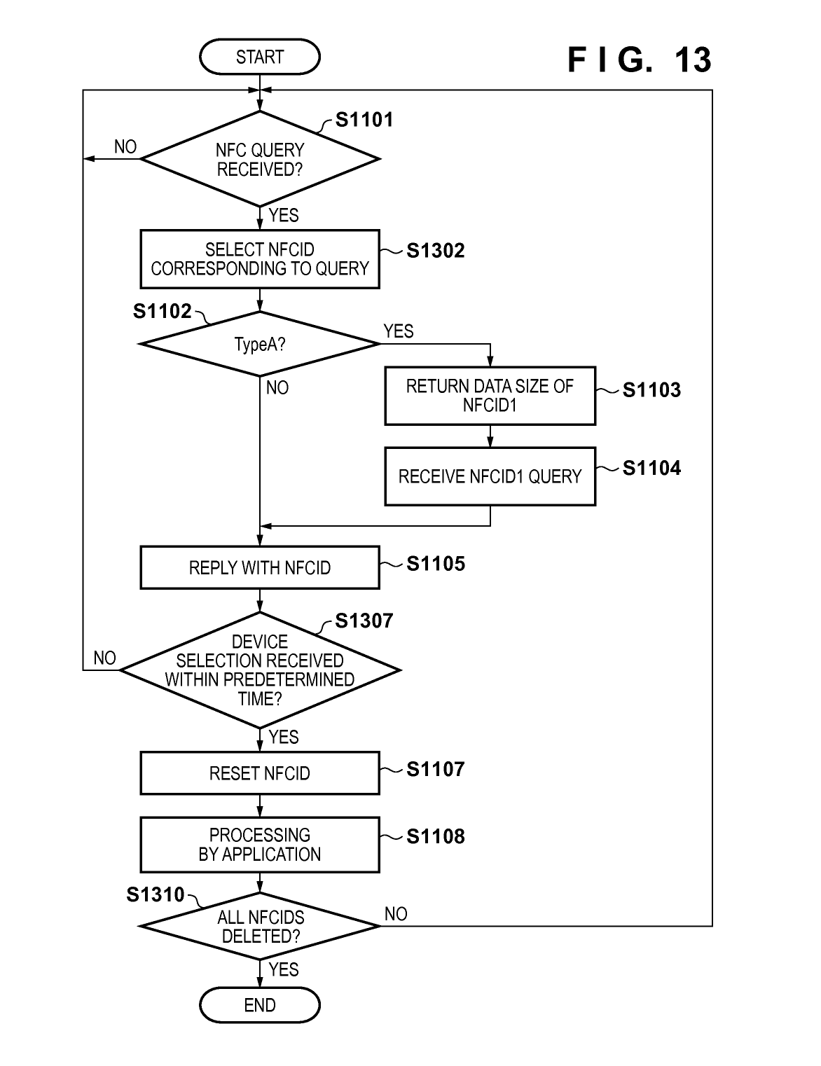

Wireless communication processing of a mobile terminal 100 according to this embodiment will be described with reference to FIG. 12. The same step numbers as in FIG. 6 denote the same processing steps, and a description thereof will be omitted.

Upon receiving a response to a command to transmit identification information within a predetermined time (YES in step S607), in step S1208, a controller 101 determines, based on an instruction received from the user via an operation unit 105, whether processes have ended for all communication apparatuses 200. For example, when different processes are performed for the plurality of communication apparatuses 200, respectively, it is determined that not all processes have ended. Upon determining that the processes have ended for all communication apparatuses 200 (YES in step S1208), the controller 101 advances the process to step S608. Upon determining that the processes have not ended for all communication apparatuses 200 (NO in step S1208), the controller 101 returns the process to step S602 and repeats processing for the remaining communication apparatuses 200. In step S1209, the controller 101 stores, in a recording unit 106, the NFCIDs of the mobile terminal 100 corresponding to the communication methods of the communication apparatuses generated in step S605, and ends the processing.

<Authentication Processing of Mobile Terminal 100>

Authentication processing of the mobile terminal 100 according to this embodiment will be described with reference to FIG. 13. Note that a program corresponding to the flowchart of FIG. 13 is stored in, for example, the recording unit 106. The program is loaded from the recording unit 106 to a RAM 102 and executed by the controller 101 in the power-on state of the mobile terminal 100. The same step numbers as in FIG. 11 denote the same processing steps, and a description thereof will be omitted.

Upon receiving a request to query whether an NFC supporting device exists (YES in step S1101), in step S1302, the controller 101 selects an NFCID corresponding to the NFC communication method from the communication apparatus 200 and stores it in the RAM 102. If the NFCIDs stored in the recording unit 106 in step S1209 include an NFCID corresponding to the same method as the NFC communication method used for the communication with the communication apparatus 200, the controller 101 preferentially selects the NFCID stored in the recording unit 106 and stores it in the RAM 102. Note that a plurality of NFCIDs corresponding to the same NFC communication method are held, an NFCID that has not been returned to the communication apparatus 200 yet is selected from the recording unit 106 and stored in the RAM 102.

After that, the controller 101 executes the processes of steps S1102 to S1105. Next, in step S1307, the controller 101 returns a response to the device selection request from the communication apparatus 200, thereby completing the authentication. For example, if the NFC communication method is of type A, a SEL_RES response is returned in response to a SEL_REQ command from the communication apparatus 200. If a device as a communication target is selected from the communication apparatus 200 within a predetermined time (YES in step S1307), the controller 101 advances the process to step S1107. If no device as a communication target is selected from the communication apparatus 200 within a predetermined time (NO in step S1307), the controller 101 returns the process to step S1101.

After that, in step S1107, the controller 101 deletes, out of the NFCIDs stored in the recording unit 106, the NFCID notified to the communication apparatus 200 in step S1105. After executing processing by an application in step S1108, the controller 101 determines in step S1310 whether an NFCID kept recorded in the recording unit 106 exists. If all the NFCIDs recorded in the recording unit 106 are deleted (YES in step S1310), the controller 101 ends the processing. If not all the NFCIDs recorded in the recording unit 106 are deleted (NO in step S1310), the controller 101 returns the process to step S1101.

Processing of a server 300 is the same as in FIG. 8. Processing of the communication apparatus 200 is also the same as in FIGS. 9 and 10.

According to the above-described second embodiment, it is possible to associate wireless communication with non-contact proximity communication between the mobile terminal 100 and the plurality of communication apparatuses 200 and authenticate the same device by holding and using a plurality of NFCIDs. Note that in the second embodiment, processing via the server 300 has been described. However, the mobile terminal 100 and the communication apparatus 200 may directly communicate without intervening with the server 300.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-254489, filed Dec. 9, 2013, which is hereby incorporated by reference herein in its entirety.

What is claimed is:

1. A communication apparatus comprising:
a first communication interface configured to connect the communication apparatus to an external device by first communication;
a second communication interface configured to connect the communication apparatus to the external device by second communication different from the first communication; and
a controller configured to control to share a communication parameter used to connect the communication apparatus to the external device via said first communication interface with the external device via said second communication interface,
wherein the communication parameter includes identification information of the communication apparatus defined by a type of communication protocol used in the first communication.

2. The apparatus according to claim 1, wherein said first communication interface corresponds to communication via a plurality of types of communication protocols in the first communication, and
the communication parameter shared by the external device includes the identification information of the communication apparatus defined by the type of communication protocol used in the first communication with the external device.

3. The apparatus according to claim 1, wherein said first communication interface corresponds to communication via a plurality of types of communication protocols in the first communication,
said controller controls to receive, via said second communication interface, the type of communication protocol used in the first communication with the external device, and
the communication parameter shared by the external device includes the identification information of the communication apparatus defined by the received type of communication protocol.

4. The apparatus according to claim 3, further comprising a generator configured to generate the identification information of the communication apparatus defined for each of the plurality of types of communication protocols.

5. The apparatus according to claim 4, wherein said generator generates the identification information of the communication apparatus upon receiving, via said second communication interface, the type of communication protocol used in the first communication with the external device.

6. The apparatus according to claim 4, wherein said controller has a function of sharing the communication parameter with a plurality of external devices via said second communication interface, and
said generator individually generates the identification information for the plurality of external devices.

7. The apparatus according to claim 1, wherein said first communication interface corresponds to communication via a plurality of types of communication protocols in the first communication, and
said controller has a function of sharing the communication parameter corresponding to each of a plurality of external devices via said second communication interface.

8. The apparatus according to claim 1, further comprising a recording controller configured to record the identification information shared with the external device via said second communication interface in, out of recording areas of the communication apparatus, a recording area readable by the external device via said first communication interface.

9. The apparatus according to claim 8, wherein if sharing of the identification information has failed, said recording controller controls not to record the identification information in the recording area.

10. The apparatus according to claim 8, further comprising a deletion unit configured to, when the identification information shared with the external device via said second communication interface is read out by the external device from the recording area readable by the external device, delete the readout identification information.

11. The apparatus according to claim 1, wherein said controller controls to transmit the communication parameter shared with the external device via said second communication interface to the external device via said first communication interface.

12. The apparatus according to claim 11, wherein said controller can share a communication parameter different from the communication parameter with the external device before transmitting the communication parameter shared with the external device via said second communication interface to the external device via said first communication interface.

13. The apparatus according to claim 11, wherein said controller controls to start communication of an application layer with the external device via said first communication interface after transmitting the communication parameter shared with the external device via said second communication interface to the external device via said first communication interface.

14. The apparatus according to claim 1, wherein the second communication has a longer communicable range than the first communication.

15. The apparatus according to claim 1, wherein the first communication is NFC, and the second communication is a wireless LAN, and
the communication protocol includes at least one of type A, type B, and type F of NFC.

16. A communication apparatus comprising:
a first communication interface configured to connect the communication apparatus to an external device by first communication having a plurality of types of communication protocols;
a second communication interface configured to connect the communication apparatus to the external device by second communication different from the first communication;
a generator configured to generate identification information of the communication apparatus according to a data format defined for each of the plurality of types of communication protocols; and
a controller configured to control communication with the external device,
wherein said controller controls to receive, via said second communication interface, a type of communication protocol to which the external device corresponds out of the plurality of types of communication protocols of the first communication,
said controller controls to transmit the identification information of the communication apparatus according to the data format defined by the received type of communication protocol to the external device via the second communication, and
when connected to the external device via the first communication, said controller controls to transmit the identification information of the communication apparatus according to the data format defined by the received type of communication protocol to the external device via the first communication.

17. A control method of a communication apparatus including a first communication interface configured to connect the communication apparatus to an external device by first communication, and a second communication interface configured to connect the communication apparatus to the external device by second communication different from the first communication, comprising:
controlling the communication apparatus so as to share a communication parameter used to connect the communication apparatus to the external device via the first communication interface with the external device via the second communication interface,
wherein the communication parameter includes identification information of the communication apparatus defined by a type of communication protocol used in the first communication.

18. A control method of a communication apparatus including a first communication interface configured to connect the communication apparatus to an external device by first communication having a plurality of types of communication protocols, and a second communication interface configured to connect the communication apparatus to the external device by second communication different from the first communication, comprising:
generating identification information of the communication apparatus according to a data format defined for each of the plurality of types of communication protocols;
controlling to receive, via the second communication interface, a type of communication protocol to which the external device corresponds out of the plurality of types of communication protocols of the first communication;
controlling to transmit the identification information of the communication apparatus according to the data format defined by the received type of communication protocol to the external device via the second communication; and
controlling, when connected to the external device via the first communication, to transmit the identification information of the communication apparatus according to the data format defined by the received type of communication protocol to the external device via the first communication.

19. A non-transitory computer-readable storage medium storing a program for causing a computer to execute as each unit of the communication apparatus according to claim 1.

20. A non-transitory computer-readable storage medium storing a program for causing a computer to execute as a unit of the communication apparatus according to claim 16.
